(19) United States
(12) Patent Application Publication
(10) Pub. No.: US 2003/0093551 A1
(43) Pub. Date: May 15, 2003

(54) Adaptive software interface

(76) Inventors: Graham Taylor, London (GB); Stephen T. Gaito, West Midlands (GB); Nigel R. Davis, London (GB); Jonathan M. Durrant, Essex (GB)

Correspondence Address: William M. Lee. Jr., Lee, Mann <Witchford, Suite 410, 209 South LaSalle Streeg, Chicago, IL, 60604-1202, US

(21) Appl. No.: 09/981,444

(22) Filed: Oct. 17, 2001

(51) Int. Cl. G06F 15/16

(52) U.S. Cl. 709/237; 709/227

(57) ABSTRACT

A data structure is described which enables at least one behavioural characteristic of a first entity to be determined by providing at least one semantic information element as meta-data which describes a characteristic of a discernable feature of the first entity using an interpretable compiler. This semantic meta-data can be compared to meta-data providing semantic information describing a characteristic of a discernable feature of at least one other entity. Meta-data may be passed dynamically with messages exchange by ORBs, or alternatively, it may be stored. In either case, a compatibility statement can be generated which collates the semantic information elements of the first entity with the semantic information elements of the at least one other entity. Each pair of collated semantic information elements can be analysed to determine at least one behavioural characteristic of the entities in the relationship, for example, whether the interface of the first entity and the interface of the second entity are compatible and the resulting behaviour expected in any ensuing dialogue between the first and second entity.

### BACKGROUND TO THE INVENTION

The present invention relates to an adaptive software interface which is able to mediate between different versions of interface definitions, and to related aspects.

The term “interfacing entities” here refers to any hardware and/or software applications and/or components which need to communicate with other hardware and/or software applications and/or components across a network, and which therefore need to establish an appropriate interface for that communication. For example, in a communications or in a computer network, it is important for various network elements to be able to communicate and cooperate when running differing applications. This requires the capability for each application to establish an appropriate interface with other applications.

Conventional applications are not able to determine whether a compatible interface exists between them, especially not using autonomous techniques. Instead they simply attempt to use capabilities of the suppliers interface, using the description of that interface they have been supplied with at compile time. Conventionally, compatibility of the interface can only be practically confirmed by exhaustively testing between the two applications. To ensure backwards compatibility between applications, many versions of an interface are usually compiled into component applications.

Conventionally, a description of an interface is provided in an appropriate interface definition language (IDL) such as, for example, OMG™'s IDL. An application must therefore incorporate a sufficiently detailed description of its interface capabilities using an IDL to enable messages from another application to be understood and actioned. However, the description provided by a conventional IDL generally cannot be broken down into smaller semantic elements, resulting in such IDLs providing a low level of granularity in any metadata generated. Here the term metadata is used in the conventional sense, i.e. data generated to describe the characteristics of other data.

A conventional IDL provides a predetermined set of interface characteristics which are confined to a predetermined parameter range. Accordingly, when one application (an initiator) seeks to initiate a dialogue with another application (a responder) over a network, an interface is required for the two applications to be able to communicate. Descriptive information on the interface abilities of the first application is conveyed as meta data to the other application facing the interface. To ensure the description of these characteristics, i.e. the meta data, is fully understood by the calling routine or function, the same version of IDL must be provided to describe the interface capabilities of the applications seeking to communicate at compile time.

When different descriptions, i.e., meta-data, is provided representing same underlying interface structure, then, despite some underlying compatibility of the two interfaces, the apparent mismatch in the format of the message arriving will generate an unmarshalling error. This generally results in the initiator and responder being unable to establish a relationship or, in the event they do connect in the differences between their interfaces generating erratic and unpredictable behaviour.

### SUMMARY OF THE INVENTION

The invention seeks to obviate and/or mitigate the problems which can occur when different descriptions describe interface characteristics, and seeks to provide an interface which displays predictable behaviour even in the event that the interface capabilities of interfacing entities are different.

A first aspect of the invention provides a method of generating an adaptive software interface for at least two connected entities, the method comprising:

generating structured meta-data providing at least one semantic information element describing a characteristic of each said entity;

collating the semantic information elements of each said entity where possible with corresponding semantic information elements of said at least one other entity; and

analysing said collated semantic information elements to establish the extent to which the interface capabilities of said at least two networked entities are compatible and generating in accordance with said established compatibility the adaptive software interface for the two entities.

The two entities, for example, initiating and responding entities such as a client application and a responding server application are preferably networked together. The network may be a computer network or a communications network for example.

The semantic information elements provide a discernable description of the meta-data, i.e., the meta-data is broken down into elements which are distinguishable by their meaning. Advantageously, this enables the meta-data to be able to provide a detailed description rather than an overview. For example, rather than state whether one of the entities has a particular feature or not, the details of the feature can be described, such as its range, and whether it is essential or not, and what may be used as a substitute if that feature is not present, and whether a default value has been assigned for that feature.

The semantic information elements may be collated dynamically during a preliminary exchange between the two entities prior to an interface being established between the two entities. Alternatively, a semantic information element may be buffered or otherwise appropriately stored for collation. Preferably, the collation is achieved using compatibility tables.

Preferably, said structured meta-data includes associated meta-data for at least one said semantic information element.

Advantageously, therefore the structured meta-data which include default values and ranges, may further provide a description of an associative relationship between various ranges. For example, a “Measurement Unit” semantics indication may provide meta-data representing a range of units, for example, MHz, THz, hours, minutes etc., and an association may be provided to indicate that a relationship exists between MHz and THz, and between hours and minutes etc.

Advantageously, associations may be provided between different entities, for example, “objects” which represent “Networks” and “Managed Elements” can be associated. More advantageously, meta-data describing the interface which describes that this association exists may be provided.

Preferably, the semantic information element describing the characteristics of said adaptive interface is provided in said meta-data in a form independent of the version of software used to generate said metadata.

Preferably, said semantic information element is generated by a compiler receiving input data from an interface description and a code template.

The compiler may be an interpretable compiler and/or parsing engine.

Preferably, the interface description includes a model of the data to be communicated across the interface and a code template, i.e. a model of the interface expressed in some format, for example in XML. For example, a model may be taken from a group of appropriate network models. The group may include for example, be a topology model or alternatively, an inventory model, performance, workflow or fault model. The code template may be manually or automatically generated.

Preferably, said semantic information element provided by said meta-data has a form which can be mapped to an appropriate transport layer and exchanged between said networked entities prior to a higher level interface being established between said networked entities.

A second aspect of the invention provides a method of determining at least one behavioural characteristic of a first entity in a relationship with at least one other entity comprising the steps of:

generating meta-data providing a structure containing at least one semantic information element describing a characteristic of the first entity;

generating meta-data providing a structure containing at least one semantic information element describing a characteristic of the at least one other entity;

collating the semantic information elements of the first entity with the semantic information elements of the at least one other entity;

analysing each pair of collated semantic information elements to determine at least one behavioural characteristic of the first entity in the relationship.

The meta-data may be stored for collation.

The relationship may be a communication dialogue initiated by the first entity with at least one other responding entity. For example, entities such as a client and server software application seeking to communicate with each other over a network need to appropriately interface. In order to assess the extent to which the client and server both have compatible interface capabilities, either or both the client and server may wish to provide meta-data indicating their interface capabilities to determine how the interface will behave.

Advantageously, this enables the client and/or server to determine how the interface will behave in the event the interface meta-data indicates that they may not be completely compatible.

The meta-data structure may be provided in a form suitable for a range of semantic information elements to be included, for example, a description of a characteristic and associated with that description, a range, and/or a default value for that characteristic.

In the step of generating meta-data for the first entity, the at least one characteristic is a characteristic of an interface of the entity, and wherein in the step of generating meta-data for the at least one other entity, the at least one characteristic is a characteristic of an interface of the at least one other entity.

The individual interface capabilities of each entity have certain interface characteristics which determine the characteristics of the interface established for the two entities when they communicate.

Preferably, if the meta-data is stored for collation, the step of storing meta-data may occur at an intermediary. The step of analysing each collated pair of semantic elements may then be undertaken by the intermediary.

In the step of storing meta-data of the first entity, a compatibility table may be generated for storing said first entity's meta-data and in the step of storing meta-data of the at least one other entity, said at least one other entity's meta-data is stored in a compatibility table.

Alternatively, the same compatibility table may be used to collate information for both entities.

A third aspect of the invention provides a method of structuring a meta-data description of data belonging to a entity, the method comprising the step of

generating at least one meta-data structure; and

providing said structure with a group of at least one semantic information element describing a characteristic of the entity;

associating a description with each said semantic information element; and

associating a default value for said range.

In said step of providing said structure with a range, at least one semantic information element describing a characteristic of the entity may be taken from a group including:

an enumeration convention; a text description; modifiability; a semantic change; an impact condition; a measurement unit; a presentation condition; an alias; a response time; a pre-operation condition; and a post-operation condition.

The above list is not exhaustive as will be apparent to those skilled in the art.

Preferably, the meta-data structure is generated in and provided in a form suitable for another entity adapted to receive said meta-data structure to determine a varying ability of the entity to support an interface according to said range of semantic information element(s).

Preferably, the group of at least one semantic information elements provides a sufficiently detailed description to indicate at least one common and/or distinguishing interface description language feature.

Preferably, at least one semantic information element is generated by an interface compiler. The interface compiler may be an interpretable compiler.

A fourth aspect of the invention provides a data probing method enabling a first entity to receive structured meta-data, the meta-data comprising a discernable description of at least one characteristic of a second entity, the method comprising the steps of:

transmitting a request for said meta-data from the first entity to the second entity, the request indicating that at least one semantic element providing a discernable description of said at least one characteristic is to be provided;

analysing said request to determine the structure of the meta-data requested;

generating discernable meta-data structured in accordance with said analysis which contains at least one semantic information element providing a discernable description of at least one characteristic of data associated with the second entity; and

returning said requested structured meta-data to said first entity.

Advantageously, the discernable description is structured semantically to enable discriminative analysis to be performed on at least one said semantic information element, said discriminative analysis enabling any difference(s), distinction(s), and/or characteristic(s) of said characteristic(s) of said second entity to be compared at the semantic level with another entity's characteristics. In particular, the interface characteristics of two entities can be compared if one entity submits such a data-probing request for meta-data to another entity with which an interface is sought to be established.

The request for information may include a plurality of semantic information elements, each element providing a description of at least one characteristic of said first entity. The returned meta-data may collate each said requested semantic information element with a corresponding semantic element provided in said request by said first entity.

Preferably, the at least one characteristic of the second entity is a characteristic of an interface capability of the second entity, and the at least one characteristic of the first entity is a characteristic of an interface capability of the first entity.

Advantageously, a probing technique is provided which enables two entities seeking to establish a relationship to determine from descriptions of their data characteristics the extent to which their interface capabilities are compatible prior to an interface between the two entities being formally established.

A fifth aspect of the invention provides a method of establishing a compatible interface between an initiator and a responder in the case where an interface of the initiator has at least one differing characteristic from an interface of the responder comprising the steps of

generating at least one meta-data structure providing at least one semantic information element for each entity, wherein each said semantic information element describes a characteristic of an interface capability of one of said entities;

collating said meta-data structures such that each semantic information element corresponding to the initiator's interface capability is collated with a corresponding semantic information element corresponding the responder's interface capability;

analysing the collated semantic information elements to determine the extent to which the initiator and the responder can generate a compatible interface;

establishing in accordance with said analysis an interface between said initiator and said responder.

Advantageously, the compatibility of two networked entities interface capabilities can be established under test conditions and the test conditions may be dynamically varied.

A sixth aspect of the invention provides a data structure providing meta-data in a form suitable for use in a data probing technique according to the fourth aspect of the invention.

A seventh aspect of the invention provides a network management system adapted to perform the steps in the method according to any one of the first to fifth aspects of the invention.

An eighth aspect of the invention provides a program for a computer in a machine readable format arranged to perform the steps of the method of any one or more of the first to fifth aspects of the invention.

A ninth aspect of the invention provides a signal comprising a program for a computer arranged to provide the steps of the method of any one or more of the first to fifth aspects of the invention.

A tenth aspect of the invention provides a network including a computer system adapted to perform steps in a method according to any one or more of the first to fifth aspects of the invention.

An eleventh aspect of the invention provides a software application capable of providing a semantic description of another application performing a computational process in a network, the semantic description having a predetermined structure which is invariant regarding the version of compiler used to generate said semantic description from said software application and said other application, said semantic description providing discernable features of at least one characteristic of said other application.

Preferably, said network is taken from the group comprising: a communications network, a data network, a computer network.

Preferably, said at least one characteristic relates to a characteristic of an ability of said other application to interface with at least one other application performing a computational process over said network.

A twelfth aspect of the invention provides an adaptive software interface generated by a method according to the first aspect. The interface enables the behavioural characteristics of interfacing entities to be considered so that an appropriate interface is generated between them.

Advantageously, the invention enables a client application to establish a dialogue with a server application to determine the conformance of the interface of an object it is querying without any requirement for information about conformance capabilities to be compiled into the client or server which would require updating when any interface changes are deployed.

Any of the above dependent features may be combined with any of the aspects of the invention in a manner apparent to those skilled in the art.

Advantageously, the generation of discrete semantic meta-data for each characteristic discernable by the interpretable compiler of an interface enables code to be reused in future versions. This enables debugging upgraded applications to be simplified.

Advantageously, any exchange of semantic meta-data does not inhibit the interface performance. For example, it may be that the performance of the interface remains within 5% of that which would be provided by a conventional interface, however, this performance objective is not restrictive.

Advantageously, an interface according to the invention is able to utilize available resources similarly to the ability of the original protocol defined interface.

Advantageously, the interface is both backwards and forwards compatible. A server is at least able to support version N of an interface and also version N−1, N−2, . . . N−x, where x may be 10 or higher even of the interface to the best of its ability so as to not force a simultaneous upgrade of servers. Optimally, an entity will not impose hard versioning restrictions, which enables greater deployment flexibility of upgraded entities across a network. This enables a gradual degradation in compatibility with N for different previous releases. Thus the invention achieves the effect of supporting several different versions of interfaces by providing a meta-data exchange which enables the compatibility of various interfaces versions to be determined.

Advantageously, the invention enables an interface having an established behaviour pattern to be created between the two applications even under circumstances which conventionally would result in either no interface being established, or only an interface with undetermined characteristics and potentially erratic behaviour being established. The invention thus enables communication to be more reliably provided between two applications even when they are not fully compatible.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 sketches an overview of the invention;

FIG. 2 shows schematically how a domain model file and an autogeneration code template is used to create a specific end application.

FIG. 3 sketches schematically two networked entities exchanging meta-data with a view to establishing their interface compatibility;

FIG. 4 shows schematically the complexity of providing forwards and backwards version compatibility between two entities;

FIG. 5 shows the layers providing abstraction between the interface stubs generated by an IDL compiler according to the invention and an application;

FIG. 6 shows schematically how metadata is exchanged between an initiating entity and a responding entity according to one embodiment of the invention;

FIGS. 7A and 7B show respective initiator and responder views of the embodiment shown in FIG. 6; and

FIG. 8 shows an overview of how meta-data is used to determine the behavioural characteristics of entities seeking to establish a relationship.

### DETAILED DESCRIPTION OF PREFERRED EMBODIMENTS

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

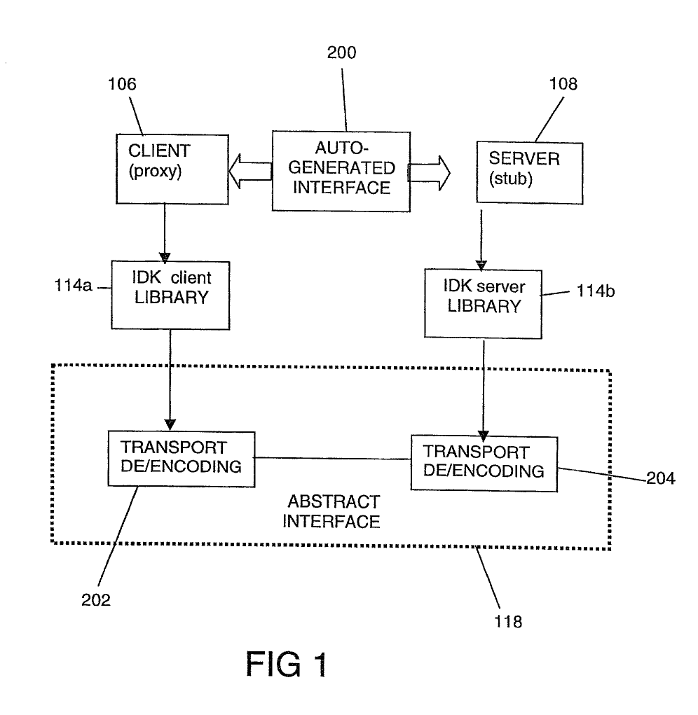

FIG. 1 provides an overview of how an interface 200 can be established according to the invention between two entities. In FIG. 1, an initiating entity or initiator 106, for example a client application, and a responding entity or responder 108, for example a server application, seek to communicate. Interface 200 is established independently of the version of the interface described by an interface definition language which is used to describe their interfacing capabilities.

FIG. 1 sketches an embodiment of the invention in which the interface 200 for an application is auto-generated. An abstract interface 118 is first generated in the transport layer between the initiator and responder. Abstract interface 118 supports a preliminary meta-data exchange in which structured, discernable semantic information elements relating to the initiator and responder interface capabilities are collated. This preliminary meta-data exchange enables the initiator 106 and the responder 108 to determine the extent to which they are compatible by analysing the collated descriptive semantic elements of their interface capabilities and characteristics. The semantic information elements describing the characteristics and features of the ability of either the responder and/or initiator to interface are described in more detail hereinbelow, but primitive examples include elements describing what unit(s) of measure are used by the entity, whether a feature is essential for the entity to interface, whether a default value has been assigned etc. The meta-data semantic elements thus provide details of the attributes, objects and classes etc of an entity's interface, regardless of whether that entity is acting as an initiator, a responder, or even as a go-between.

The meta-data describing the interface capability of a client application is generated by a compilation process with an interface library of the invention, the IDK interface library 114a. The term IDK here is a proprietary term for the interface library of the invention. An equivalent process occurs on the server side of the application in which a stub for the server 108 is compiled with IDK library 114b to provide appropriate meta-data.

The compiled meta-data provide interface descriptions which are then appropriately encoded at the transport layer and exchanged between the client and server. It will be appreciated by those skilled in the art that whilst generally a bi-directional exchange of meta-data is appropriate, nonetheless in some instances it may be appropriate for a unidirectional exchange of meta-data to take place.

The meta-data exchanged is provided in an abstract or generic format which enables a higher level interface between the client and server applications to be automatically generated even in the event that a different version of interface definition language or a different version of interface is used to describe the two applications' interfacing capabilities. The meta-data exchange thus enables a certain quality of interface or level of compatibility to be provided in the event that different versions of interface are supported by different networked entities. Moreover, the meta-data is semantically structured according to the invention to support an interface being established even when the interface capabilities of the two applications differ.

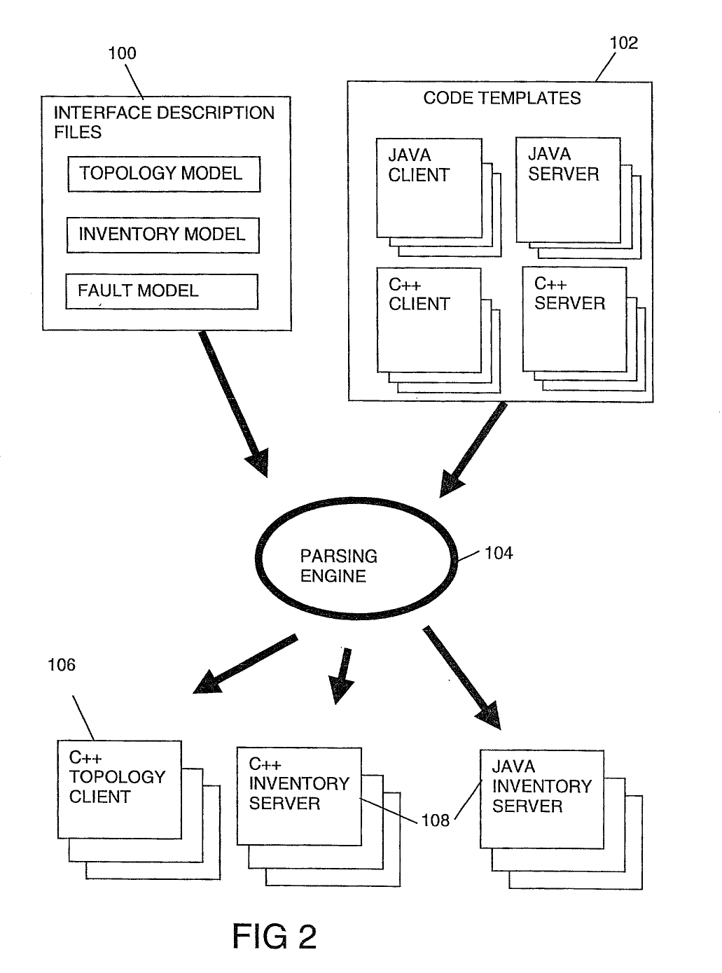

To generate client/server meta-data using the IDK interface library, the client proxy and server stubs need to possess appropriately formatted interface descriptions. FIG. 2 shows how a series of interface description files 100 are provided which provide details of the interface for a variety of network models. Three examples of network models are shown, a topology model, an inventory model, and a fault model, but it will be appreciated by those skilled in the art that interface description files for other models may be provided.

A variety of code templates are also indicated in FIG. 2, for example, Java and C++ templates for client and server applications are provided. Again, it will be appreciated by those skilled in the art that the invention is not limited to the specific examples shown in FIG. 2.

In order to generate appropriate client proxies and server stubs the interface description files and code templates are compiled or parsed by parsing engine 104. Such a parsing engine may, for example, be an XSL (Extensible Stylesheet Language) compiler.

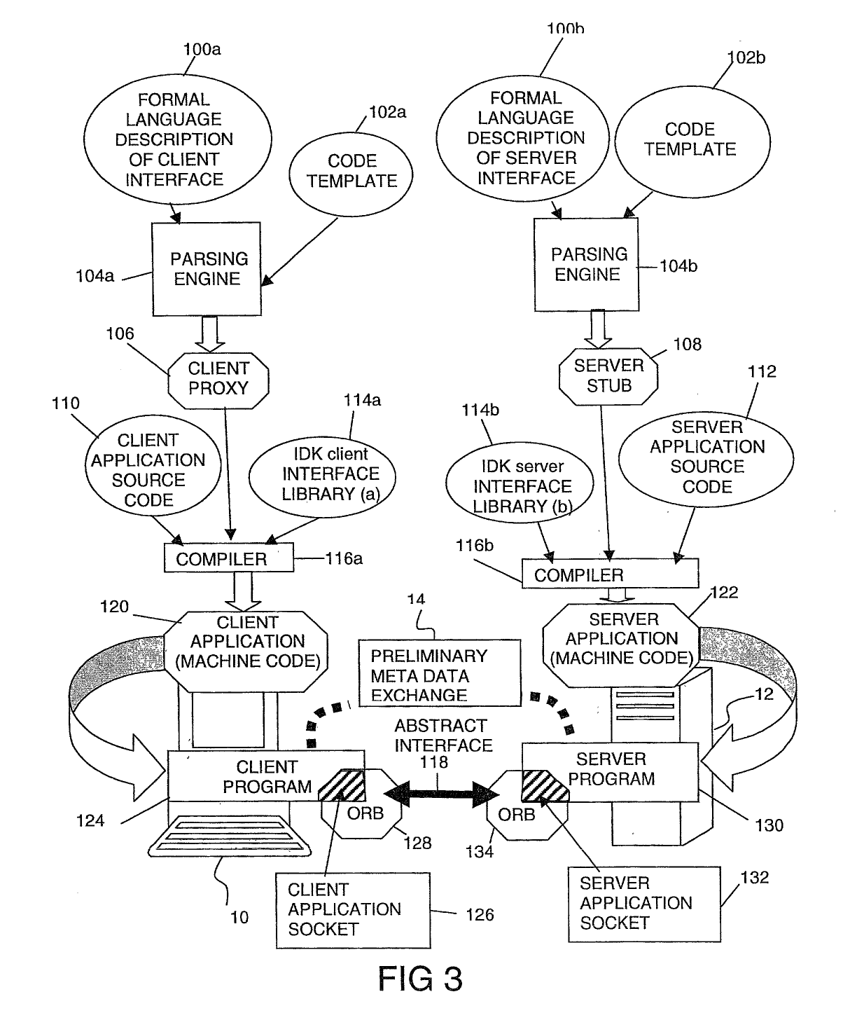

Parsing engine 104 generate client proxies and server stubs for the appropriate network modes which can be compiled with the client application source code 110 and the IDK interface library 114 into appropriate client application machine code such as FIG. 3 shows schematically. Parsing engine 104 provides a function equivalent to an interpretable compiler, for example, it compiles appropriate semantic descriptions of the interface capabilities of the client application, for example, which can describe the application objects, operations on those objects, object attributes, and associated parameter values interface characteristics and capabilities.

Referring again to FIG. 2 of the drawings, the compiler 104 draws on at least one relevant domain model file 100 (which may be XML based) which contains appropriate details of the semantics of the interface (for example, objects, attributes, operations, and meta-data).

The domain model file 100 defines the interactions and information which flows through the application and does not need to contain any detail of how the application source code is to be structured. The examples shown in FIG. 2 of domain models include a topology model, an inventory model, and a fault model. For example, in a network management environment, a topology model file includes a definition of a trail object and a definition of operations on the trail object, such as a GetAllTrails( ) operation which returns an appropriate iterator.

The XSL compiler also draws on code templates 102, which are used by the autogeneration process, for example, autogenerated XSL based code templates. The autogeneration code templates define how the application source code is to be structured but are not specific to any application domain.

The code templates function as source language templates and have substitution tags embedded within the code to enable the code to be specialised for a particular domain by combination with the domain files, for example by identifying a target deployment role (e.g. client or server), a target deployment language (e.g. C++ or JAVA), and/or any target deployment implementation patterns (e.g. Jacobson's interface objects).

In FIG. 2, the autogeneration code templates 100 are client or server, JAVA or C++ code templates which the XSL compiler then combines with appropriate domain model files to autogenerate end-application source code proxies and stubs for example, such as a C++ topology Client or Java Inventory Server or C++ Inventory Server.

The method according to the invention of autogenerating the client and server proxies and stubs includes the steps of:

i) generating domain model files, for example, topology, inventory, and fault models;

ii) providing auto-generation code templates, for example, Java and C++ clients and servers; and

iii) compiling using an interpretable compiler the domain model files and the auto-generation code templates to create end application specific source code.

It is not required to auto-generate the code templates, and code templates may, in some instances, be provided manually. In either instance, the interface models generated are in both cases language and technology independent, thus, for example, the same interface model can be run over JAVA/RMI templates and C++/CORBA templates.

A schematic diagram providing a more detailed overview of how two networked entities 10, 12 can establish an appropriate interface and so communicate is provided by FIG. 3. In FIG. 3, an initiating entity or initiator 10 is shown as a client program which wants to communicate with the responding entity or responder 12, here a server program. The top part of FIG. 3 indicates compile time processes, whereas the bottom section indicates “run-time” behaviour.

An interface between the client program 10 and the server program 12 is established by first providing a preliminary exchange of meta-data to determine the extent to which the two programs have compatible interfaces. The client proxy 106 and server stub 108 are prepared by using a parsing engine 104 as described above.

Consider initially the client side of the interface. The client proxy 106 is compiled with an IDK interface library 114a to generate meta-data providing a structured and discernable/discrete semantic description of certain characteristics of the client application 10 interface. Other client application source code 110 may also be compiled to generate appropriate client application machine code 120.

The metadata describing the interface capabilities of the client application is generated using a parsing engine 104 and language compiler 116a for example, a conventional C/C++ or Java compiler which generates appropriate client application machine code.

The high level constructs of the shared interface are mapped into a specific “abstract” representation to be transported over a specific transport protocol, for example, CORBA as FIG. 3 shows. However, other lower level transport mapping may be provided as is appropriate and obvious to those skilled in the art, for example, JMS (Java Message Service), IP (Internet Protocol), or EJB/RMI (Enterprise Java Beans/Resource Manager Interface). Alternatively, a parsing engine such as XSL may be used to describe the interface and generate (or autogenerate) the application higher level interface and the mappings to a specific transport protocol.

In FIG. 3, the client proxy 106 is drawn upon by compiler 116a together with the IDK interface description library 114a to create the appropriate semantic code which contains meta-data detailing the client interface capability. This semantic code is incorporated in the respective client application machine source code 120.

The meta-data provides descriptive data of the objects, operations on objects, attributes and associated parameters of the application interface. Unlike that provided by conventional interface description languages, the meta-data of the invention has a sub-structure and can be broken down into constituent parts and analysed at a layer which is normally encapsulated by conventional meta-data.

The meta-data generated according to the invention is in a semantic form which is discernable at the object, operations on objects, attributes etc. level to any enquiring entity. For example, an object class is meta-data for an object instance. The class describes the attributes and behaviour at a level of abstraction away from the instance itself. Conventional IDL syntax for an object, i.e. a GDMO (Generic Data Model for Object), is relatively simple and supports relatively restrictive meta-data only on the class, its operations and attributes. Whether a particular attribute can be replaced with an equivalent attribute and whether a certain subset of class, operation and attribute enables an interface to be established even if no equivalent subset exists in the corresponding entity is not provided by a conventional interface definition language. The interface definition language of the invention enables such information to be provided either as additional meta-data or by enabling the individual semantic elements of the interface definition language to be analysed, i.e. for the individual meaningful elements of the meta-data to be understood in the context of their description of the interface.

Accordingly, the interface definition library of the invention supports a more sophisticated interface definition language syntax which enables comparison of the individual semantic elements of the language to be performed. For example, additional meta-data can be provided indicating:

enumeration convention for old values to new values and vice versa;

a text description of an attribute/operation/entity etc., for example, which may be used to produce comments;

modifiability, for example which could be used in a GUI (Graphics User Interface) to indicate which fields are allowed to be changed;

semantic changes, for example which could be used to drive auto-configuring intelligent caches;

impact, for example which could be used to drive warning messages about traffic which could be affected;

measurement units, for example which could be used to display units such as MHz;

presentation, for example which could be used to indicate whether an attribute should be put on dynamic GUI or hidden;

aliases or nicknames, for example which could be used to enable a Ul (user interface or upper interface) to display information in different contexts (such as SONET/SDH nicknames);

response time, for example which could be used to indicate whether an operation has the performance necessary to drive a Ul; and/or

pre- and post-operation conditions for a object/attribute, which enable these to be analysed by an entity.

It is this additional syntax of the meta-data which enhances the versatility of the meta-data by providing a way to allocate default values and to indicate a range of further, versatile information. Such information can be used by applications to establish a weil-behaved interface even in the event where the interface capabilities and/or descriptions of the interface capabilities differ for the two or more entities which are trying to communicate.

In contrast, the syntax of conventional IDL meta-data only enables two entities which have different interface capabilities and/or differing interface meta-data to compare their overall lack of compatibility. The invention instead enables the entities to analyse semantically the elements of their interface capabilities regardless of whether these differ or are consistent.

Although a preliminary meta-data exchange may occur prior to formally establishing a dialogue between the client and server applications, as shown in the embodiment of the invention of FIG. 1 for example, this need not be the case. Meta-data may instead be exchanged dynamically during any dialogue between two or more entities which is advantageous if two entities interface characteristics are affected by the dynamic conditions of the network connection between the entities.

The invention provides meta-data which enables one or more behavioural characteristics of the client/server interface to be determined prior to the interface being formally established. For example, it is probable that the entities interface will have some degree of compatibility even in the event that the interface descriptions for each entity were compiled using slightly different versions of compiler 116.

By ensuring that the descriptive meta-data is provided in a form which is independent of the version of the compiler used to generate it, an interface can still be established despite the interfaces having different meta-data descriptions. By providing associated features for meta-data semantic elements and by providing the ability for meta-data to be semantically deconstructed, semantic analysis of the meta-data to determine those discernable meta-data elements which are consistent between the client interface and the server interface is possible. Any consistent elements are assessed to determine whether they are sufficient to support an interface having a desired behavioural characteristic, for example, stability or a certain level of compatibility.

In the embodiment of the invention shown in FIG. 3, once the meta-data exchange has indicated that an interface relationship between the client application 10 and the server application 12 would have a desired behavioural characteristic, the relationship between the two applications is initiated. The meta-data is encoded at the transport level and the ORBs 30, 32 (Object Request Brokers) exchange messages between the client and server application using an appropriate protocol, for example GIOP/IIOP (General Inter-ORB Protocol/Internet Inter-ORB Protocol). The autogenerated interface is thus mapped to the CORBA IDL, implemented by CORBA objects in the chosen programming language using the IIOP protocol. The interface generated thus does not inhibit the use of DII or other ORB or CORBA services.

In other embodiments of the invention other protocol mappings could be used, such as CORBA/IDL, RMI, SOAP (Simple Object Access Protocol), as well as XML/RPC. For example, in other embodiments of the invention it is possible to autogenerate an interface implemented using Java RMI, which maps to a Java remote interface using RMI-JRMP or RMI-IIOP; or using EJB which maps to the EJB home and EJB remote interface, implemented by session beans, entity beans, message-driven beans and Java objects and which has an underlying RMI-IIOP protocol. If an interface is implemented using JMS, the interface maps to a JMS message structure with the underlying protocol determined by the message orientated middle ware. If an interface is implemented using XML the underlying protocol is flexible, examples being HTTP and JMS.

The additional syntactic structure of the meta-data provides semantic information on discernable features and so enables processes such as transaction management, security, persistence, object lookup, concurrency, load balancing and fault tolerance and fail-over to become more interoperable and version independent. This is advantageous in that it enables development and maintenance costs to be minimized when deploying upgrades and increases the interoperability over various systems over a network.

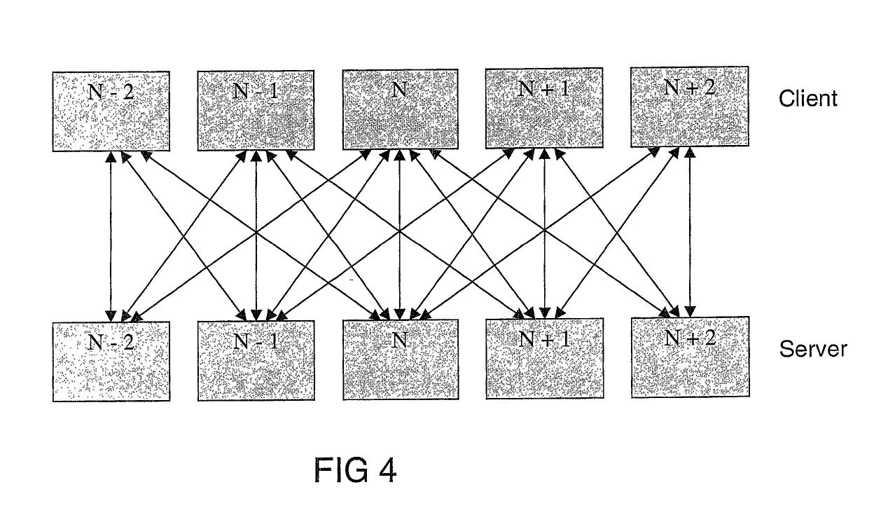

Advantageously, an interface generated according to the invention is both backwards and forwards compatible. Referring now to FIG. 4 of the accompanying drawings, a relationship can be established between a client and server independently of the release version installed on each piece of equipment. FIG. 4 shows how if the current version on a client is version N, it is necessary to ensure future and backwards compatibility with a range of versions (N−2 to N+2 in FIG. 2 for example) potentially installed on a server with which the client wishes to interface.

Advantageously, the invention enables any entity in a network to support and interface with a range of release equipment. Syntactic meta-data enables at least version N of an interface to be compatible with earlier and later versions, in most cases with versions N−1 and/or N+1, and potentially even later/earlier versions such as N−2, N+2.

By providing a means to generate an adaptive or version independent software interface, application software code can remain unchanged even when syntactic or semantic changes have occurred. An abstract interface is generated which does not have any high-level semantics as these are likely to change from release to release. This avoids any issues associated with conventional syntactic upgrade which would result in compilation and subsequent deployment problems.

The invention therefore provides a way for component applications to be independently verified as robust and to ensure they do not core dump, i.e., terminate with an unrecoverable error, despite any interface differences between two networked entities. Component applications can be subjected to a range of test scenarios covering partial, expected and expanded interface definitions and can be tested to ensure that the component applications exhibit appropriate degradation/enhancement of their capabilities as their interface changes.

Architecture

In the invention, an application model are expressed in a machine parsable form, for example, in XML. An application model specifies objects, attributes and operations via an interface and meta-data describing an interface model. A machine parsable application model is used to auto-generate a language coded stub that an application programmer needs to use. The application model itself is able to access meta-data and “unversioned” interface data to enable more intelligent forwards compatible applications.

Referring back to FIG. 2, the model parsing engine 104 receives input both from the interface model (for example resource management, topology etc) and from the code templates (for example a client versioning C++ code template etc.) The code templates are essentially target language files (for example C++/Java) which include markers to identify points at which model specifics need to be added. For example, a class or an attribute or an operation or meta-data information. The parsing engine 104 copies the code templates and substitute the model specifics (topological classes, attributes, operations, meta-data support) where marked appropriately. The templates are able to provide highly complex functionality such as meta-data support and versioning support as the parsing engine 104 has no inherent understanding of the templates function.

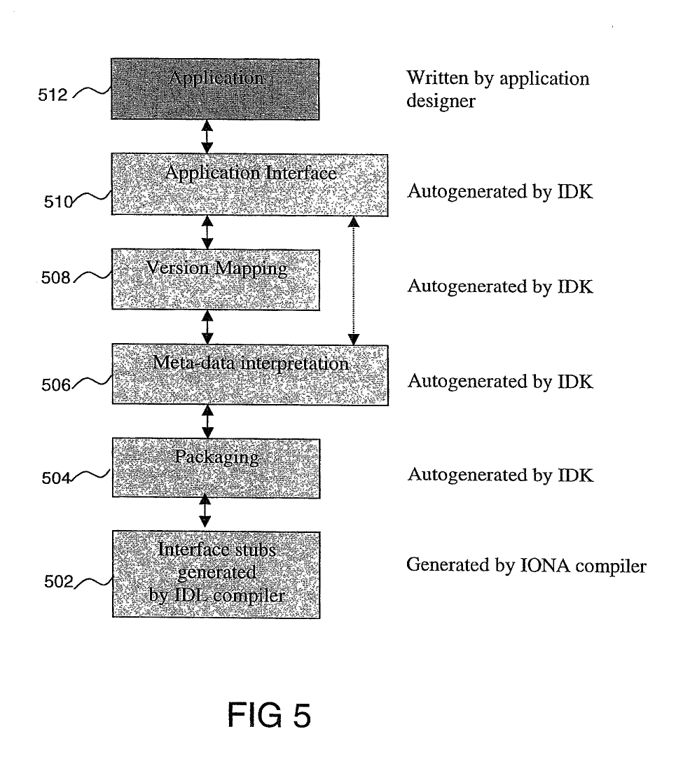

Referring now to FIG. 5, the client view of the layered architecture of one C++/CORBA embodiment of the invention shown in FIG. 2 is illustrated schematically. In other embodiments of the invention, not all of these layers may be present as is obvious to one skilled in the art.

An interface stub is generated by an interface description compiler in 502 which is highly abstract and does not change, for example and IONA™ IDL compiler may be used. The interface stub generated is then used in and/or uses a packaging layer 504. Packaging layer 504 involves the syntactic conversion of application objects into abstract transport encoding/decoded objects using the IDK Interface Description Library. This layer is autogenerated by the parsing engine. The packaging layer abstract encoded objects are used in and/or use meta-data in interpretation layer 506. Interpretation layer 506 deals with policies and the consequences of self-descriptive information about the interface and again is autogenerated by the parsing engine.

The meta-data interpretation layer 506 is used in and/or uses versioning layer 508. Versioning layer 508 reconciles which aspects of the interface remain valid for use by the application if the interface descriptions are different versions and/or have some fundamental difference. The versioning layer is autogenerated also by the parsing engine.

The versioning layer is used in and/or uses application interface(s) layer 510 in which the parsing engine creates an application stub which is similar to the conventional interface stub. The application stub from the interface layer 510 is used in and/or uses application layer 512 as the application designer considers appropriate.

As mentioned above, layers 504 to 510 are autogenerated by the parsing engine in the best mode of the invention contemplated by the inventors. Alternatively, these layers may be generated manually. The generation of an interface stub by the IDL compiler may be from any interpretably compiler, e.g., an IONA compiler or an XML compiler etc, which can provide appropriate semantic definitions. Examples in XML are given below, however, the skilled person in the art will appreciate that the examples given are illustrative of basic concepts and that more sophisticated constructs can be provided using the principles demonstrated.

i) Name Semantics Indication

TABLE 1
Name Semantics indication

| Name | Range | Description | Default |
|---|---|---|---|
| “name” | n/a | The name of the attribute | N/A |

This construct defines the name of the attribute. If this statement is not provided, then the attribute is ill defined and the operation will fail. Example: The attribute example is defined:

<dataContainerList name=“Attribute”>

<nvp name=“name” value=“example”/> . . .

Further definitions

</dataContainerList>

iii) Description Semantics Indication

TABLE 2
Description Semantics Indication

| Name | Range | Description | Default |
|---|---|---|---|
| “Description” | N/A | A description of the attribute's | N/A |
| | | purpose | |

This construct defines the purpose of the attribute. This may be used by the application as help text and by the auto-generator to comment the code. Example: The attribute example is described as follows:

<dataContainerList name=“Attribute”>

<nvp name=“name” value=“example”/>

<nvp name=“description” value=“The example attribute will be used to explain the various meta-data constructs definable over the interface.”/> . . .

Further definitions

</dataContainerList>

iii) Modifiability Semantics Indication

TABLE 3
Modifiability Semantics Indication

| Name | Range | Description | Default |
|---|---|---|---|
| “Modifiability” | “readOnly” | The attribute value | “readOnly” |
| | | cannot be set. | |
| | “readWrite” | The attribute value may | |
| | | be set. | |

This construct defines whether the attribute is read-only or read write. Example: The attribute example can be modified.

<dataContainerList name=“Attribute”>

<nvp name=“name” value=“example”/>

<nvp name=“modifiability” value=“readWrite”/> . . .

Further definitions

</dataContainerList>

iv) Type Semantics Indication

TABLE 4
Type Semantics Indication

| Name | Range | Description | Default |
|---|---|---|---|
| “C++Type” | “string” | The type of the attribute for | N/A |
| | “unsigned long” | a C++ target language | |
| | “Name” | | |
| “JavaType” | “java.lang.string” | The type of the attribute for | N/A |
| | “unsigned long” | a Java target language | |
| | “Name” | | |

This construct defines the type of the attribute for the target language. Example: The attribute should be a string if Java or C++ is the target language.

<dataContainerList name=“Attribute”>

<nvp name=“name” value=“example”/>

<nvp name=“CxxType” value=“string”/>

<nvp name=“JavaType” value=“java.lang.string”/> . . .

Further definitions

</dataContainerList>

v) Attribute Change Semantic Indication

TABLE 5
Attribute Change Semantic Indication

| Name | Range | Description | Default |
|---|---|---|---|
| “Source” | “system” | The attribute has a value that | “system” |
| | | can only be automatically changed | |
| | | by the system (read-only). | |
| | “user” | The attribute has an user editable | |
| | | value (either via TM, EC or LCT). | |
| | “both” | The attribute has a value that | |
| | | can be changed both by user or | |
| | | automatically by system. | |
| “Frequency” | “often” | The attribute has a value that | “rare” |
| | | can only be automatically changed | |
| | | by the sys-tem AND this is likely | |
| | | to happen frequently. An attribute | |
| | | can be considered to change | |
| | | “Often” when its value | |
| | | CAN change roughly on a per | |
| | | second basis (e.g. attributes | |
| | | which value is calculated | |
| | | for each received frames). | |
| | “rare” | The attribute has a value that | |
| | | can only be automatically changed | |
| | | by the system, but this is not | |
| | | likely to happen very often. Such | |
| | | attributes could usually change | |
| | | on a daily basis, as opposed to | |
| | | on a second basis for the | |
| | | “Often” one. It is | |
| | | assumed that a user changeable | |
| | | attribute will changed rarely. | |
| “Notified” | “yes” | Any changes to this attribute are | “no” |
| | | notified over the interface | |
| | “no” | Any changes to this attribute | |
| | | are not notified over the interface | |

This construct (see table 5) gives some indication on the nature of the attribute such as whether it is machine controlled or man controlled, and whether or not this attribute value is likely to change often. In one embodiment of the invention, the value of this attribute can only be changed by the system but is not likely to change very often—when it does there will be notification. Example:

<dataContainerList name=“Attribute”>

<nvp name=“name” value=example”/>

<dataContainerList name=“ChangeDescription”>

<nvp name=“Source” value=“system”/>

<nvp name=“Frequency” value=“rare”/>

<nvp name=“Notified” value=“yes”/>

</dataContainerList> . . .

Further definitions

</dataContainerList>

vi) Default Value Semantics Change Indication

TABLE 6
Default Value Semantics Change indication

| Name | Range | Description | Default |
|---|---|---|---|
| “DefaultValue” | N/A | This attribute has a default value | N/A |
| | | that can be used if a value is not | |
| | | supplied over the interface. | |

This construct defines the value a default value for the attribute. A default value can be provided, but this is not mandatory. An empty string is a valid <DefaultValue>. If the default statement is not provided, then the attribute has no valid default value.

Example: If no value is supplied for this attribute over the interface then the value “splendid” should be substituted fro the application to use.

<dataContainerList name=“Attribute”>

<nvp name=“name” value=“example”/>

<nvp name=“DefaultValue” value=“splendid”/> . . .

Further definitions

</dataContainerList>

vi) Mandatory Semantics Change Indication

TABLE 7
Mandatory Semantics Change Indication

| Name | Range | Description | Default |
|---|---|---|---|
| “Mandatory” | “yes” | This attribute must be explicitly | “no” |
| | | supplied into or explicitly returned | |
| | | in the response by an operation. If | |
| | | not then the operation will be failed. | |
| | “default” | As above or a <Default> is supplied | |
| | | by any operation. If there is no | |
| | | <Default> and the data is | |
| | | not explicitly passed then the | |
| | | operation will be failed. | |
| | “no” | This attribute may be omitted. | |

This construct defines whether the presence of the attribute is so key that any operation dealing with its absence should be failed and an exception sent through to the application. Example: If the attribute “example” is not included then fail the operation:

<dataContainerList name=“Attribute”>

<nvp name=“name” value=“example”/>

<nvp name=“Mandatory” value=“yes”/> . . .

Further definitions

</dataContainerList>

vii) Impact Semantics Change Indication

TABLE 8
Impact Semantics Change Indication

| Name | Range | Description | Default |
|---|---|---|---|
| “TrafficImpact” | “yes” | Changing this attribute value | “no” |
| | | will have an effect on traffic. | |
| | “no” | Changing this attribute value | |
| | | will have no effect on traffic. | |
| “Warning” | N/A | Carries warning message (if | N/A |
| | | appropriate) which can be | |
| | | displayed on the user interface | |

This construct can be used to describe what the possible traffic impacts are when the corresponding attribute is modified (e.g. loss of traffic when setting a loopback). This information can then be used by an application to warn the user of the consequences of changing the attribute, and even anticipate them. Impacts will be assigned a severity indicator; there can be several impacts when changing the value of an attribute.

Example: If the attribute “example” is not included then fail the operation.

<dataContainerList name=“Attribute”>

<nvp name=“name” value=“example”/>

<nvp name=“Mandatory” value=“yes”/>

<dataContainerList name=“Impact”>

<nvp name=“TrafficImpact” value=“yes”/>

<nvp name=“Warning” value=“May cause scrambled

eggs to appear purple”/>

</dataContainerList> . . .

Further definitions

</dataContainerList>

viii) Measurement Unit Semantics Indication

TABLE 8
Measurement Unit Semantics Indication

| Name | Range | Description | Default |
|---|---|---|---|
| “MeasurementUnit” | “hrs” | Hours | N/A |
| | “min” | Minute | |
| | “sec” | Second | |
| | “msec” | Milli-second | |
| | “dd.mm.yy” | Date | |
| | “percent” | Percentage | |
| | “dec”” | Decimal | |
| | “hex” | Hexadecimal | |
| | “oct” | Octal | |
| | “MHz” | MegaHertz | |
| | “THz” | Tera Hertz | |

This construct gives an indication of the measurement unit(s) used for the attribute value Example: If the attribute “example” is not included then fail the operation:

<dataContainerList name=“Attribute”>

<nvp name=“name” value=“example”/>

<nvp name=“MeasurementUnit” value=“MHz”/> . . .

Further definitions

</dataContainerList>

ix) Presentation Semantics Indication

TABLE 9
Presentation Semantics Indication

| Name | Range | Description | Default |
|---|---|---|---|
| “Presentation” | “yes” | This attribute can be displayed | “no” |
| | | in meta-data driven UI | |
| | “no” | This attribute shouldn't be dis- | |
| | | played in Meta-data driven UI | |
| | “special” | This attribute should only be | |
| | | displayed in a “debug” | |
| | | mode, e.g. for engineer | |
| | | controlled test attributes. | |

This construct defines whether the presence of the attribute is so key that any operation dealing with its absence should be failed and an exception sent through to the application. Example: The attribute “example” should not be displayed.

<dataContainerList name=“Attribute”>

<nvp name=“name” value=“example”/>

<nvp name=“Presentation” value=“no”/> . . .

Further definitions

</dataContainerList>

x) Alias Semantic Indication

TABLE 10
Alias Semantic Indication

| Name | Range | Description | Default |
|---|---|---|---|
| “AlternativeName” | N/A | Another name for the attribute | N/A |
| “Context” | N/A | Context in which the name | N/A |
| | | is used | |

This construct is used to define alias names.

Example: The attribute “example” has several display names.

<dataContainerList name=“Attribute”>

<nvp name=“name” value=“example”/>

<dataContainerList name=“Alias”>

<nvp name=“AlternativeName” value=“nice”/>

<nvp name=Context” value=“SDH”/>

</dataContainerList> <dataContainerList name=“Alias”>

<nvp name=“AlternativeName” value=“nasty”/>

<nvp name=“Context” value=“SONET”/>

</dataContainerList> . . . Further definitions

</dataContainerList>

By providing meta-data containing semantic indications, the invention enables both forwards and backwards compatibility as FIG. 4 illustrated. The forwards and backwards compatibility can be supported by both client and server sides of an interface. For example, this enables network management software to be deployed without the need to upgrade all network elements in a communications network for example. Similarly, new applications whether versions of network elements or network management applications can be deployed without upgrading the integrated network management system.

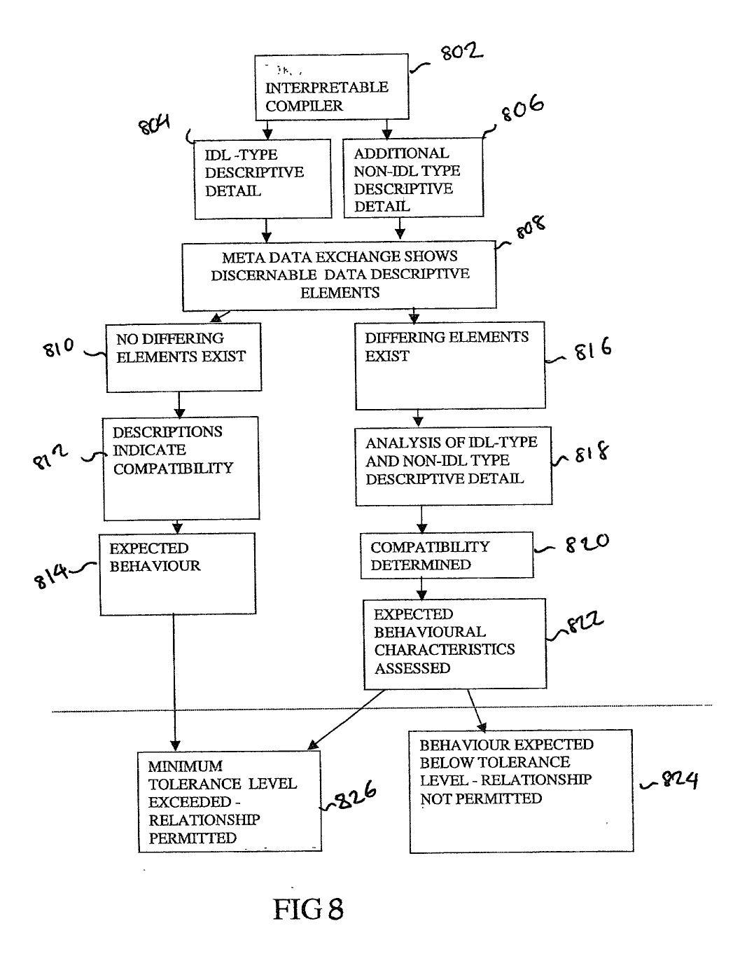

As is described later with reference to FIG. 8, this is achieved by enabling a client and server to exchange both version and meta-data semantic information on connection to allow both to obtain information on the capabilities of each others interface. Alternatively, an intermediary may collate information on the interfaces of the client and server and compare their capabilities. In either case, reconciliation is conducted between the transport and application layers to ensure that the effect any differences in the capabilities of the interfaces are minimised.

Changes may arise due to changing technology or to correct oversight or error in a previous interface definition. The invention enables these changes to be incorporated into the semantic detail the meta-data exchanges between two networked entities.

Addition to an Interface.

An addition does not alter the previous nature of an interface. The invention enables a client application to be able to choose to either simply ignore the additional feature of the interface or to make use of it using supporting meta-data.

Additions to an interface may include new attributes associated with an object. By providing a versioning layer to “mask or mark” new attributes to allow application to ignore (if it wants to). The new attributes can be made available to the application by providing the appropriate meta-data to enable their use.

Conventional applications use lower layers to shield additional changes to an interface. In contrast, the invention provides intelligent applications (such as, for example, a termination point provisioning application) which is capable of effectively learning what attributes can be provisioned (using appropriate Meta-data). The addition to an interface could be presented via a dynamic UI (or upper interface) to a user.

An addition to the operations an interface can perform could include for example, new methods associated with an object. To make such methods available to the application appropriate meta-data is provided. For example, in an embodiment of the invention where a new client and server are deployed to an application, the application can simply “pass through” or ignore any request it does not understand.

Change to an Interface

A change can cause incompatibilities between the software at either end of an interface. A change may therefore require some functionality provided by a client application to be switched off. For example, a change to an interface could include corrections or removals of attributes associated with an object. If an object instance is to be considered valid it needs to adhere to a core set of “mandatory” attributes, without which it cannot be handled by the application. A core attribute is marked by “mandatory” meta-data tag in an application domain model. If a server cannot provide the core set of attributes or determine if any default values are provided, the object instance is treated as invalid and marked accordingly to enable the application to ignore it.

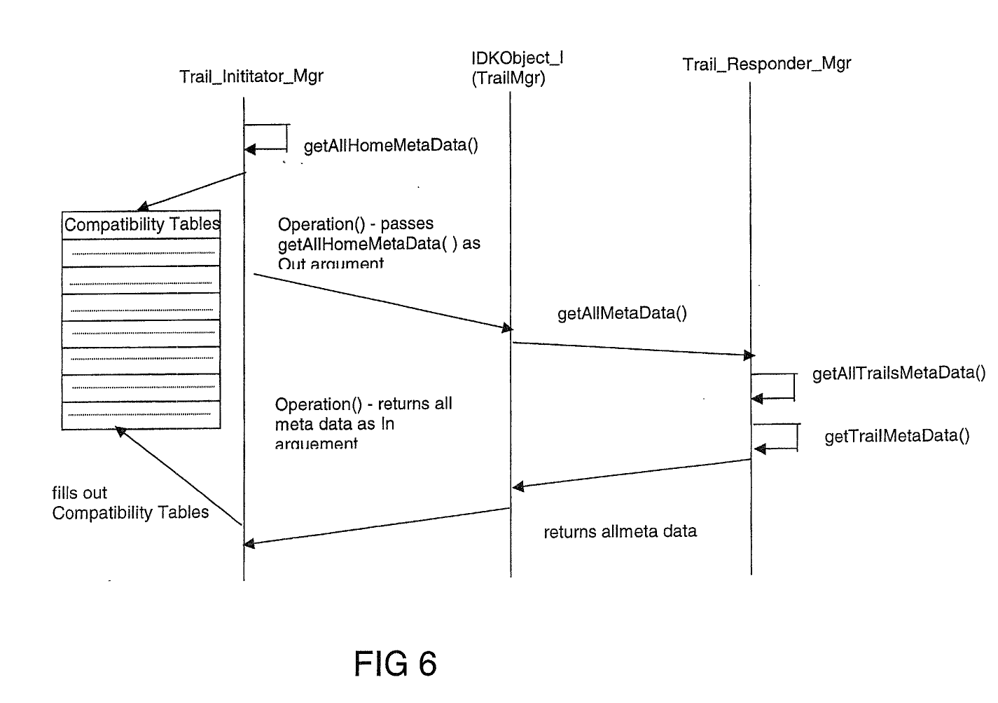

Referring back to FIG. 6, the versioning layer is able to use meta-data to establish if any core “mandatory” attributes are not supplied and if no defaults have been established. If a mandatory attribute is missing the operation generates an exception. Alternatively, if all mandatory attributes are present, the application can still operate in a “minimal support configuration”.

The invention also enables applications to be component tested to characterise their behavior as the interface is degraded and to enable each interface operation to return an exception. This enables “core dumps” to be avoided and for applications to degrade in a controlled manner if incompatibility between the client and server interface exists. Thus an interface could still support “getAIINEs” but not “getAllCircuitPacks” if the circuitpack object definition has changed too much.

An interface may also change for example, by adding additional parameters to the interface definition in a subsequent release. If a default is not provided for the new parameter, any attempt by a client application to use this operation will be declined. Similarly, if the operations of an interface change so that a method is removed, the versioning layer is able to pass an exception back to the application. The versioning layer is able to use meta-data to establish if any new “mandatory” or essential parameters have not been supplied and is able to determine if any default exists or not. In the event of any problem such as a default not being provided, an exception can be passed back to the application. A more subtle semantic change may have taken place to render an operation incompatible. In this case an “incompatible” tag marks the change with a version number to ensure subsequent version of the interface do not attempt to use the old operation.

One embodiment of the invention enables an application to be subjected to a variety of interface scenarios to test their components. The applications are component tested to characterise the application behaviour as the interface is degraded and to enable each interface operation to return an exception independently. Again, this enables an application to undergo a degradation in its behavior rather than simply terminate with an unrecoverable error.

By providing a fixed IDL which does not need to evolve syntactic versioning problems can be obviated. This is achieved by describing an abstract model in the IDL (such as a class having a list of attributes and operations). Providing all interfaces support this concept, the syntax does not need to evolve. The nature of the information carried by the abstract IDL can evolve as required and this is provided by appropriate meta-data.

In the case where two interfaces differ greatly in capability, the overlap in the descriptive semantic detail will reduce and objects, attributes, and operations of the abstract interface will cease to be available.

How Application Code Uses Compatibility Information

The processing required to deduce compatibility is performed using compatibility tables. The end application is presented with several convenience functions which enable it to query the capabilities of an interface. The various aspects of the interface such as each class, attribute, operation, and parameter etc., will have a companion operation (for example, of the form XXXsupported( )), which the application can use. Any direct calls or access to an unsupported aspect of the interface generates an exception.

The interface is coded with an understanding of its own capabilities when generated. Subsequently, when, for example, a CORBA connection is established between two entities, the entity initiating the process, e.g., the client, or an intermediary, can retrieve meta-data from the responding entity, e.g. the server. The client may want to provide meta-data to prompt the return of appropriate meta-data in alternative embodiments of the invention. Once the client or intermediary has collated both sets of meta-data, the meta-data can be analysed to determine exactly where and/or how the client and server are or are not compatible. In alternative embodiments of the invention, this comparison can be performed on the server side, or be determined by the load of either the client, or server, or of any intermediary available.

Compatibility Table Construction

Compatibility tables are either generated by an initiator which is able to use meta-data from a responder and the initiator's own meta-data or by an intermediary which has access to both the initiator and responder meta-data and which can generate a compatibility table. The responder meta-data describes the operation and network object support that the responder application is providing. The initiator's own meta-data describes the operation and network object support the initiating application is providing. The compatibility tables can then be used in the implementation of initiator support type methods and meta-data grouping functionality.

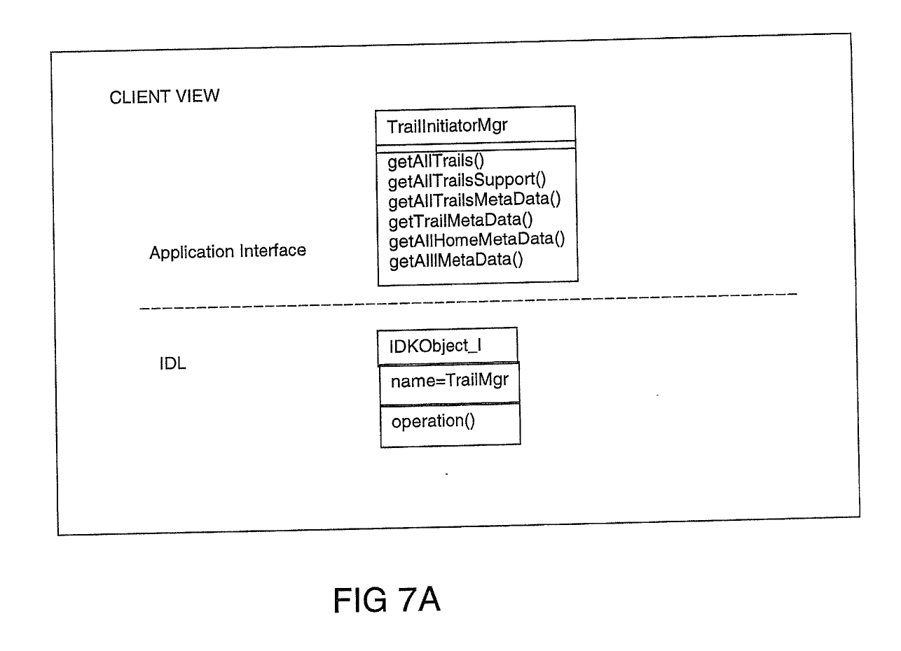

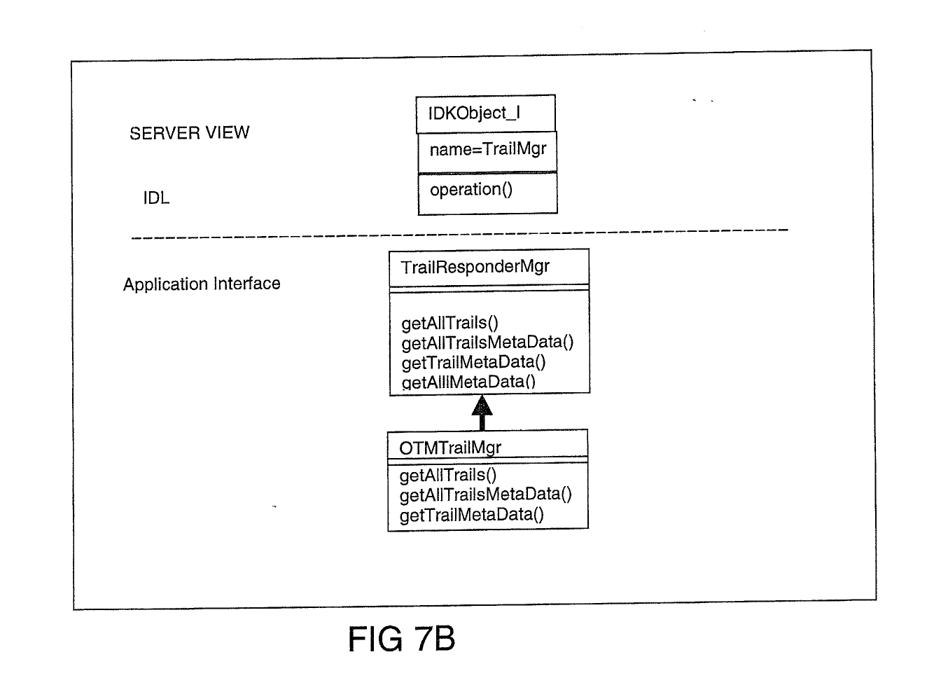

Referring now to FIGS. 6, 7A and 7B of the accompanying drawings, an example is shown of how a compatibility table can be created by an initiator application in a network management scenario

FIG. 6 shows schematically how a trail initiator manager application TrailInitatorMgr collates its own initiator meta-data and performs an operation, Operation( ), to collate meta-data from a trail responder manager application, TrailResponderMgr. The Operation( ) passes a request (getAllMetaData( ) in FIG. 6) for obtaining meta-data as an Out argument. An object instance of the requesting entity (IDKObject_I (TrailMgr) in FIG. 6) is used to pass the request on to the trail responder application which then collates its own meta-data using appropriate operations (in FIG. 6, getAllTrailMetaData( ) and getTrailMetaData( ).

Once all available meta-data has been collated by the trail responder manager TrailResponderMgr, this is returned using the requesting entity object instance IDKObject_I (TrailMgr) which then returns the meta-data as an In argument in the operation, Operation( ), back to the Trail Initiator Manager, TrailInitiatorMgr. The Trail Initiator Manager creates a compatibility table using both the initiator meta-data and the returned meta-data from the trail responder manager.

FIGS. 7A and 7B show the respective client and server views of how a compatibility table can be constructed and how the fixed, abstract, interface definition language of the invention can be used to generate abstract objects and operations thereof.

TABLES 11a, 11b
Example Compatibility Tables

| Operation | Meta-data | Context | Object Instance Reference List |
|---|---|---|---|
| getAllTrails( ) | data | home | Ref to IDKObject_I |
| getAllTrails( ) | data | responder | Ref to IDKObject_I |
| Helper Object | Meta-data | Context | Object Instance Reference list |
| Trail | data | home | Ref to IDKObject_I |
| Trail | data | responder | Ref to IDKObject_I |

Referring to FIGS. 6 and 7A, in this embodiment of the invention, in the event that a new server is notified to the Trail Initiator manager, the trail initiator manager object will being to retrieve meta-data by calling the getAllHomeMetaData( ), which will call the getAllTrailsMetaData( ) and getTrail-MetaData( ) method, and by calling getAllMetaData( ) which will encode the request and call operation( ) on the TrailMgr instance of the IDKObject_I object.

The returned meta-data will be entered in the Compatibility tables shown above. Default meta-data will be autogenerated for getAllTrails-MetaData( ) and getTrailMetaData( ) as specified in an XML model. The client application designer can edit this meta-data so that it indicates support as required.

If for example the getAllTrails( ) method is not supported by the client application, then the meta-data autogenerated for getAllTrailsSupport( ) should be deleted. The operation Operation( ) will return encoded meta-data from the server. This data will be decoded and entered in the Compatibility Tables as shown above. The returned data contains meta-data on each method supported at the server and also meta-data about the Trail class itself.

Referring now to FIG. 7B of the drawings, in the embodiment shown, the responder, or server, is able to autogenerate a class which inherits form the TrailResponderMgr. This class provides default implementation for each pure virtual method that exists in the TrailResponderMgr class. For non meta-data retrieval methods the default implementation is to throw a NOT_IMPLEMENTED exception. A server application designer can provide a specific implementation as required.

For meta-data retrieval methods the default implementation is to return meta-data as specified in the XML model The application designer can edit this meta-data so that it indicates support as required. If, for example, the getAllTrails( ) method is not supported by the server, the meta-data should be deleted. On receiving a getAllMetaData( ) request the TrailResponderMgr will call getAllTrailsMetaData( ) and getTrailMetaData( ) and assemble the retrieved meta-data into a single block of meta-data that will be returned to the client.

When an initiator (for example client) application calls an operation such as getAllTrails( ), glue code is able to locate the entry of any responder (for example server) and the entry of the initiator home entry for getAllTrails( ) in the Compatibility Tables. It will compare the meta-data and if they are the same will allow the request to be passed to the server. If they are not the same it will throw an exception. If an entry is not found in the Compatibility Tables it implies that the operation is not supported and an exception will be thrown. A similar check will be done between the meta-data for the home and server Trail entries in the Compatibility Tables. If they do not match an exception will be thrown for the getAllTrails( ) operation.

At a basic level a simple matching check can be performed, in the best mode contemplated by the invention, other tests are performed to allow gradual degradation between initiator and responder applications whose interfaces differ, for example when either a client and/or a server is a different release

For example, if a client application calls getAllTrailsSupport( ) as shown in FIG. 7A, then at a basic level either true or false can be returned. The client application can use this information to make decisions on what functionality it can support itself.

Alternatively, more sophisticated functionality support can be provided. By providing a functionality support class, an application can instantiate this class and define the attributes, operations and entities which are key to a certain area of its functionality. An operation, for example Supported( ), can be called to determine if the functionality added to an object can be supported or not. This provides an advantage over known support bit methods in that there are no support bit files to be maintained and the functional areas can be as fine or coarse grained as the application desires.

TABLE 12
Functionality Support Class

FunctionalitySupport
void AddAttribute( )
void AddOperation( )
void Add Entity( )
boot Supported( )

As an example, an inventory application could use a FunctionalitySupport instance to determine if the functionality required to drive a shelf level graphics application is supported. The application can use the Add . . . ( ) methods shown in Table x above to define the entities (e.g. CircuitPack, Shelf, . . . ), operations (e.g. GetAllCircuitPacks, . . . ), attributes (circuitPackHeight,circuitPackWidth, or PECCode, . . . ) required to display meaningful shelf level graphics.

The application would then call Supported( ) to determine if the complete set of functionality is supported.

Using the Compatibility Tables the Supported( ) method compares the home and server meta-data for each entity/operation/attribute that was previously added. If there are irreconcilable incompatibilities then Supported( ) will return false, otherwise it will return true. Using this result the application can disable or enable the shelf level graphics functional area.

In the best mode contemplated by the inventors the interface is object-orientated and is able to use polymorphism and/or inheritance. In the best mode language mappings are available to C++ or Java, but any other language supporting the interface could be used in alternative embodiments of the invention. Although it is unusual for all elements in an interface to be needed in any relationship, each type of relationship between two entities will require various critical components to ensure that the minimum tolerance level of compatibility is provided below which the relationship is either unstable or non-existent. By subjecting the invention to test rig conditions for appropriate domain models, verification of the compatibility between two networked entities such as a client and server application can be obtained for a variety of conditions. The invention provides a method of establishing a compatibility table which provides support for an initiator and responder to generate an interface having a gradually degrading scale as the characteristics of the initiator and responder differ, rather than be subjected to rigid compatible or incompatible interface conditions.

Thus as FIG. 8 of the drawings shows, using a domain model parsing engine and an interpretable compiler 802 meta-data is generated which provides discernable semantic elements which describe both conventional IDL type descriptive detail 804 and additional descriptive detail 806. Both types of meta-data 804, 806 is exchanged 808 either directly between two or more networked entities wishing to establish a dialogue or via one or more intermediaries, although in alternative embodiments it may be desirable only to exchange additional meta-data.

The meta-data 804, 806 can be analysed at any entity or intermediary either according to the load of each entity or intermediary or according to a predetermined criteria.

If the meta-data exchanged indicates no differing semantic detail 810, the descriptions imply the interfaces of each entity are inter-compatible 812, and that the dialogue between the entities is likely to be well-behaved over the interface 814. In this case the entities can continue to establish their dialogue.

If differing semantic elements are detected 816, the meta-data can be analysed 816 to determined the compatibility of the interfaces of each entity 818. The resulting analysis can be used to determine whether the dialogue between the two entities is likely to be well-behaved or whether the interface is likely to display any degradation in its capability 820. The level to which the interfaces of each entity is able to support the proposed dialogue can be used to determine whether a dialogue will ensue or what kind of dialogue can be supported.

The expected behavioural characteristics of the interface can be assessed when determining the level to which each interface of the entities are compatible with each other. After the capabilities of the interfaces for a particular dialogue sought are assessed, if a minimum tolerance level is determined or has been already established by meta-data, an entity or intermediary can choose whether to establish the dialogue 826 or not 824.

In alternative embodiments of the invention, meta-data can be exchanged dynamically during a dialogue to indicate any change in conditions, such as a drop in the level of interface compatibility (for example, such as may arise if there is a change in a network condition). If the compatibility level drops below the tolerance level the dialogue can be discontinued or interrupted.

Numerous modifications and variations to the features described above in the specific embodiments of the invention will be apparent to a person skilled in the art. The scope of the invention is therefore considered not to be limited by the above description but is to be determined by the accompanying claims. For example, the invention can be provided to run on various computer systems, for example, Solaris, Windows, HP-UX operating systems. The terms client and server are considered to be equivalent to the terms initiator and responder in the appropriate communications network embodiments of the invention. The invention enables business to business (B2B) applications running on networked computer systems to interface more reliably and has numerous other applications and the scope of the protection offered by the claims is not limited to the specific embodiments described hereinabove with reference to the accompanying drawings.

It will be appreciated by the person skilled in the art that more than one entity may be party to an interface, and that the roles of server and client may be exchanged as initiator and responder The terms initiating/responding entity and initiator/responder are considered equivalent in this description, and the term “entity” relates to both roles. The skilled person in the art will appreciate that the invention distinguishes between the “version of the interface” and the “version of the interface definition language”, the same interface may be described by different versions of interface definition language and different versions of interface may be described by the same version of interface definition language.

The text of the abstract repeated herein below is hereby incorporated into the description:

A data structure is described which enables at least one behavioural characteristic of a first entity to be determined by providing at least one semantic information element as meta-data which describes a characteristic of a discernable feature of the first entity using an interpretable compiler. This semantic meta-data can be compared to meta-data providing semantic information describing a characteristic of a discemable feature of at least one other entity.

Meta-data may be passed dynamically with messages exchange by ORBs, or alternatively, it may be stored. In either case, a compatibility statement can be generated which collates the semantic information elements of the first entity with the semantic information elements of the at least one other entity. Each pair of collated semantic information elements can be analysed to determine at least one behavioural characteristic of the entities in the relationship, for example, whether the interface of the first entity and the interface of the second entity are compatible and the resulting behaviour expected in any ensuing dialogue between the first and second entity.

1. A method of generating an adaptive software interface for at least two networked entities, the method comprising:
generating structured meta-data providing at least one semantic information element describing a characteristic of each said entity;
collating the semantic information elements of each said entity where possible with corresponding semantic information elements of said at least one other entity; and
analysing said collated semantic information elements to establish the extent to which the interface capabilities of said at least two networked entities are compatible and generating in accordance with said established compatibility the adaptive software interface for the two entities.

2. A method as claimed in claim 1, wherein the step of collating occurs dynamically during a preliminary exchange between the two entities prior to an interface being established between the two entities.

3. A method as claimed in claim 1, wherein said structured meta-data includes associated meta-data for at least one said semantic information element.

4. A method as claimed in claim 1, wherein the semantic information element describing the characteristics of said adaptive interface is provided in said meta-data in a form independent of the version of software used to generate said metadata.

5. A method as claimed in claim 1, wherein said semantic information element is generated by a compiler receiving input data from an interface description and a code template.

6. A method as claimed in claim 1, wherein said interface description includes a model of the data to be communicated across the interface and a code template.

7. A method as claimed in claim 1, wherein said semantic information element provided by said meta-data has a form which can be mapped to an appropriate transport layer and exchanged between said networked entities prior to a higher level interface being established between said networked entities.

8. A method of determining at least one behavioural characteristic of a first entity in a relationship with at least one other entity comprising the steps of:
generating meta-data providing a structure containing at least one semantic information element describing a characteristic of the first entity;
generating meta-data providing a structure containing at least one semantic information element describing a characteristic of the at least one other entity;
collating the semantic information elements of the first entity with the semantic information elements of the at least one other entity;
analysing each pair of collated semantic information elements to determine at least one behavioural characteristic of the first entity in the relationship.

9. A method as claimed in claim 8, wherein the meta-data structure is provided in a form suitable for indicating at least one semantic element taken from the group including: a description, a range, a default value.

10. A method as claimed in claim 8, wherein in the step of generating meta-data for the first entity, the at least one characteristic is a characteristic of an interface of the entity, and wherein in the step of generating meta-data for the at least one other entity, the at least one characteristic is a characteristic of an interface of the at least one other entity.

11. A method of structuring a meta-data description of data belonging to an entity, the method comprising the step of
generating at least one meta-data structure; and
providing said structure with a range of at least one semantic information element describing a characteristic of the entity;
associating a description with each said semantic information element; and
associating a default value for said range.

12. A method as claimed in claim 11, wherein in said step of providing said structure with a range, the at least one semantic information element describing a characteristic of the entity is taken from the group including:
an enumeration convention; a text description; modifiability; a semantic change; an impact condition; a measurement unit; a presentation condition; an alias; a response time; a pre-operation condition; and a post-operation condition.

13. A method as claimed in claim 11, wherein the meta-data structure is generated in and provided in a form suitable for another entity adapted to receive said meta-data structure to determine a varying ability of the entity to support an interface according to said range of semantic information element(s).

14. A method as claimed in claim 11, wherein the semantic information provides a sufficiently detailed description to indicate at least one common and/or distinguishing interface description language feature which is generated by an interpretable compiler.

15. A data probing method enabling a first entity to receive structured meta-data, the meta-data comprising a discernable description of at least one characteristic of a second entity, the method comprising the steps of:
transmitting a request for said meta-data from the first entity to the second entity, the request indicating that at least one semantic element providing a discernable description of said at least one characteristic is to be provided;
analysing said request to determine the structure of the meta-data requested;
generating discernable meta-data structured in accordance with said analysis which contains at least one semantic information element providing a discernable description of at least one characteristic of data associated with the second entity; and
returning said requested structured meta-data to said first entity.

16. A method as claimed in claim 15, wherein at least one characteristic of the second entity is a characteristic of an interface capability of the second entity, and the at least one characteristic of the first entity is a characteristic of an interface capability of the first entity.

17. A data structure in an application which provides meta-data in a form suitable for use in a data probing method enabling a first entity to receive structured meta-data, the meta-data comprising a discernable description of at least one characteristic of a second entity, the method comprising the steps of:
transmitting a request for said meta-data from the first entity to the second entity, the request indicating that at least one semantic element providing a discernable description of said at least one characteristic is to be provided;
analysing said request to determine the structure of the meta-data requested;
generating discernable meta-data structured in accordance with said analysis which contains at least one semantic information element providing a discemable description of at least one characteristic of data associated with the second entity; and
returning said requested structured meta-data to said first entity.

18. A method of establishing a compatible interface between an initiator and a responder in the case where an interface of the initiator has at least one differing characteristic from an interface of the responder comprising the steps of
generating at least one meta-data structure providing at least one semantic information element for each entity, wherein each said semantic information element describes a characteristic of an interface capability of one of said entities;
collating said meta-data structures such that each semantic information element corresponding to the initiator's interface capability is collated with a corresponding semantic information element corresponding the responder's interface capability;
analysing the collated semantic information elements to determine the extent to which the initiator and the responder can generate a compatible interface;
establishing in accordance with said analysis an interface between said initiator and said responder.

19. A network management system adapted to perform the steps in a method of generating an adaptive software interface for at least two entities, the method comprising:
generating structured meta-data providing at least one semantic information element describing a characteristic of each said entity;
collating the semantic information elements of each said entity with those stored semantic information elements of said at least one other entity; and
analysing said collated semantic information elements to establish the extent to which the interface capabilities of said at least two networked entities are compatible and generating in accordance with said established compatibility the adaptive software interface for the two entities.

20. A program for a computer in a machine readable format arranged to perform steps in a method of generating an adaptive software interface for at least two networked entities, the method comprising:
generating structured meta-data providing at least one semantic information element describing a characteristic of each said entity;
collating the semantic information elements of each said entity with those semantic information elements of said at least one other entity; and
analysing said collated semantic information elements to establish the extent to which the interface capabilities of said at least two networked entities are compatible and generating in accordance with said established compatibility the adaptive software interface for the two entities.

21. A signal comprising a program for a computer arranged to perform steps in a method of generating an adaptive software interface for at least two networked entities, the method comprising:
generating structured meta-data providing at least one semantic information element describing a characteristic of each said entity;
collating the semantic information elements of each said entity with those semantic information elements of said at least one other entity; and
analysing said collated semantic information elements to establish the extent to which the interface capabilities of said at least two networked entities are compatible and generating in accordance with said established compatibility the adaptive software interface for the two entities.

22. A network including a computer system adapted to perform steps in a method of generating an adaptive software interface for at least two networked entities, the method comprising:
generating structured meta-data providing at least one semantic information element describing a characteristic of each said entity;
collating the semantic information elements of each said entity with those semantic information elements of said at least one other entity; and
analysing said collated semantic information elements to establish the extent to which the interface capabilities of said at least two networked entities are compatible and generating in accordance with said established compatibility the adaptive software interface for the two entities.

23. A software application capable of providing a semantic description of another application performing a computational process in a network, the semantic description having a predetermined structure which is invariant regarding the version of compiler used to generate said semantic description from said software application and said other application, said semantic description providing discernable features of at least one characteristic of said other application.

24. A software application as claimed in claim 23, wherein said network is taken from the group comprising:
a communications network, a data network, a computer network.

25. A software application as claimed in claim 23, wherein said at least one characteristic relates to a characteristic of an ability of said other application to interface with at least one other application performing a computational process over said network.

26. An adaptive software interface for at least two networked entities generated by;
generating structured meta-data providing at least one semantic information element describing a characteristic of each said entity;
collating the semantic information elements of each said entity where possible with corresponding semantic information elements of said at least one other entity; and
analysing said collated semantic information elements to establish the extent to which the interface capabilities of said at least two networked entities are compatible and generating in accordance with said established compatibility the adaptive software interface for the two entities.
